(19) United States
(12) Patent Application Publication
(10) Pub. No.: US 2018/0323414 A1
(43) Pub. Date: Nov. 8, 2018

(54) METHOD FOR PRODUCING NONAQUEOUS ELECTROLYTE SECONDARY BATTERY SEPARATOR

(71) Applicant: Sumitomo Chemical Company, Limited, Tokyo (JP)

(72) Inventors: Hiroki HASHIWAKI, Niihama-shi (JP); Chikara MURAKAMI, Osaka (JP)

(21) Appl. No.: 16/038,808

(22) Filed: Jul. 18, 2018

Related U.S. Application Data
(62) Division of application No. 15/362,892, filed on Nov. 29, 2016.

(30) Foreign Application Priority Data
Nov. 30, 2015 (JP) 2015-233935

(51) Int. Cl. H01M 2/16; H01M 10/0525; H01M 10/0561; H01M 10/0564

(52) U.S. Cl. CPC H01M 2/1653; H01M 10/0525; H01M 10/0561; H01M 10/0564; H01M 2300/002; H01M 2300/0025; H01M 2300/0034; H01M 2300/0037; H01M 2/1673

(57) ABSTRACT

Provided is a nonaqueous electrolyte secondary battery including a porous film containing polyolefin as a main component, the nonaqueous electrolyte secondary battery separator having a parameter X of not more than 20, the parameter X being calculated based on the following equation: X=100×|MD tan δ−TD tan δ|/{(MD tan δ+TD tan δ)/2}, where MD tan δ is tan δ in a machine direction of the porous film and TD tan δ is tan δ in a transverse direction of the porous film, MD tan δ and TD tan δ each being obtained by viscoelasticity measurement carried out with respect to the porous film at a frequency of 10 Hz and a temperature of 90° C. the nonaqueous electrolyte secondary battery separator making it possible to reduce an increase in internal resistance which increase is caused by repeated charge and discharge.

This Nonprovisional application claims priority under 35 U.S.C. 119 on Patent Application No. 2015-233935 filed in Japan on Nov. 30, 2015, the entire contents of which are hereby incorporated by reference.

### TECHNICAL FIELD

The present invention relates to a separator for a nonaqueous electrolyte secondary battery (hereinafter referred to as a “nonaqueous electrolyte secondary battery separator”), a laminated separator for a nonaqueous electrolyte secondary battery (hereinafter referred to as a “nonaqueous electrolyte secondary battery laminated separator”), a member for a nonaqueous electrolyte secondary battery (hereinafter referred to as a “nonaqueous electrolyte secondary battery member”), a nonaqueous electrolyte secondary battery, and a method for producing a nonaqueous electrolyte secondary battery separator.

### BACKGROUND ART

Nonaqueous electrolyte secondary batteries, such as lithium-ion secondary batteries, each of which has a high energy density, have been widely used as batteries for use in devices such as a personal computer, a mobile phone, and a portable information terminal. These days, efforts are being made to develop nonaqueous electrolyte secondary batteries as automotive-use batteries.

As a separator used for a nonaqueous electrolyte secondary battery such as a lithium-ion secondary battery, a microporous film containing a polyolefin as a main component has been used.

A nonaqueous electrolyte secondary battery has a problem of a deterioration in cycle characteristic thereof. This deterioration occurs for the reasons below. Specifically, an electrode of the battery repeatedly swells and contracts in line with charge and discharge, and thus stress is generated between the electrode and a separator of the battery. This causes an electrode active material to, for example, fall cut, and consequently causes an increase in internal resistance. The deterioration in cycle characteristic thus occurs. In order to address the problem, there have been proposed techniques for increasing adhesion between a separator and an electrode by coating a surface of the separator with an adhesive material such as polyvinylidene fluoride (Patent Literatures 1 and 2). Note, however, that since an adhesive material with which a surface of a separator is coated causes blockage of pores on the surface of the separator, repeated charge and discharge reduce the area of the separator through which lithium ions can pass. This causes a problem of an increase in internal resistance in the battery.

### CITATION LIST

### Patent Literatures

[Patent Literature 1]

Japanese Patent No. 5355823 (Publication date: Nov. 27, 2013)

[Patent Literature 2]

Japanese Patent Application Publication, Tokukai, No. 2001-118558 (Publication date: Apr. 27, 2001)

### SUMMARY OF INVENTION

### Technical Problem

The present invention has been made in view of the problems, and an object of an embodiment of the present invention is to provide a nonaqueous electrolyte secondary battery separator, a nonaqueous electrolyte secondary battery laminated separator, a nonaqueous electrolyte secondary battery member, a nonaqueous electrolyte secondary battery, and a nonaqueous electrolyte secondary battery separator producing method each of which makes it possible to reduce an increase in internal resistance which increase is caused by repeated charge and discharge.

### Solution to Problem

The inventors accomplished the present invention by finding, for the first time, that a smaller amount of anisotropy of tan δ obtained by measurement of viscoelasticity of a porous film allows a lower rate of increase in internal resistance in a nonaqueous electrolyte secondary battery through a charge and discharge cycle test.

A nonaqueous electrolyte secondary battery separator in accordance with an embodiment of the present invention includes a porous film containing polyolefin as a main component, the nonaqueous electrolyte secondary battery separator having a parameter X of not more than 20, the parameter X being calculated based on the following equation:

X100×|MD tan δ−TD tan δ|/{(MD tan δ+TD tan δ)/2},

where MD tan δ is tan δ in a machine direction of the porous film and TD tan δ is tan δ in a transverse direction of the porous film, MD tan δ and TD tan δ each being obtained by viscoelasticity measurement carried out with respect to the porous film at a frequency of 10 Hz and a temperature of 90° C.

A nonaqueous electrolyte secondary battery separator in accordance with an embodiment of the present invention is preferably arranged to have a puncture strength of not less than 3 N.

A nonaqueous electrolyte secondary battery laminated separator in accordance with an embodiment of the present invention includes: a nonaqueous electrolyte secondary battery separator mentioned above; and a porous layer.

A nonaqueous electrolyte secondary battery member in accordance with an embodiment of the present invention includes: a cathode; a nonaqueous electrolyte secondary battery separator mentioned above or a nonaqueous electrolyte secondary battery laminated separator mentioned above; and an anode, the cathode, the nonaqueous electrolyte secondary battery separator or the nonaqueous electrolyte secondary battery laminated separator, and the anode being provided in this order.

A nonaqueous electrolyte secondary battery in accordance with an embodiment of the present invention includes: a nonaqueous electrolyte secondary battery separator mentioned above or a nonaqueous electrolyte secondary battery laminated separator mentioned above.

A method in accordance with an embodiment of the present invention for producing a nonaqueous electrolyte secondary battery separator including a porous film containing polyolefin as a main component includes the steps of: (i) mixing ultra-high molecular weight polyolefin and a low molecular weight hydrocarbon; (ii) mixing a pore forming agent and a mixture obtained in the step (i); (iii) forming, into a sheet, a mixture obtained in the step (ii); (iv) obtaining the porous film by stretching the sheet obtained in the step (iii).

The method can further include the step of: annealing, at a temperature of less than Tm hut not less than (Tm−30° C.), the porous film obtained in the step (iv), Tm being a melting point of the polyolefin contained in the porous film.

### Advantageous Effects of Invention

The present invention yields an effect of providing a nonaqueous electrolyte secondary battery separator, a nonaqueous electrolyte secondary battery laminated separator, a nonaqueous electrolyte secondary battery member, and a nonaqueous electrolyte secondary battery each of which makes it possible to reduce an increase in internal resistance which increase is caused by repeated charge and discharge.

### BRIEF DESCRIPTION OF DRAWINGS

FIG. 1 is a graph showing a relationship between a parameter X and a rate of increase in internal resistance in each of Examples and Comparative Examples.

### DESCRIPTION OF EMBODIMENTS

An embodiment of the present invention is described below. Note, however, that the present invention is not limited to such an embodiment. The present, invention is not limited to arrangements described below, but can be altered by a skilled person in the art within the scope of the claims. An embodiment derived from a proper combination of technical means each disclosed in a different embodiment is also encompassed in the technical scope of the present invention. Note that, a numerical range “A to B” herein means “not less than A and not more than B” unless otherwise specified.

[1. Separator]

(1-1) Nonaqueous Electrolyte Secondary Battery Separator

A nonaqueous electrolyte secondary battery separator in accordance with an embodiment of the present invention includes a porous film that is filmy and is provided between a cathode and an anode of a nonaqueous electrolyte secondary battery.

The porous film only needs to be a base material that is porous and filmy, and contains a polyolefin-based resin as a main component (polyolefin-based porous base material). The porous film is a film that (i) has therein pores connected to one another and (ii) allows a gas or a liquid to pass therethrough from one surface to the other.

The porous film is arranged such that in a case where the battery generates heat, the porous film is melted so as to make the nonaqueous electrolyte secondary battery separator non-porous. This allows the porous film to impart a shutdown function to the nonaqueous electrolyte secondary battery separator. The porous film can be made of a single layer or a plurality of layers.

The inventors accomplished the present invention by finding, for the first time, that in a porous film containing a polyolefin-based resin as a main component, (a) anisotropy of tan δ obtained by dynamic viscoelasticity measurement carried out with respect to the porous film at a frequency of 10 Hz and a temperature of 90° C. is associated with (b) an increase in internal resistance which increase is caused by repeated charge and discharge.

Tan δ obtained by the dynamic viscoelasticity measurement is expressed by the following equation:

tan δ=E″/E′

where E′ represents a storage modulus, and E″ represents a loss modulus. The storage modulus indicates reversible deformability under stress, and the loss modulus indicates non-reversible deformability under stress. As such, tan δ indicates followability of deformation of a porous film with respect to a change in external stress. The porous film which has a smaller amount of in-plane anisotropy of tan δ has more isotropic deformation followability with respect to a change in external stress, so that the porous film can more homogeneously deform in a surface direction thereof.

The nonaqueous electrolyte secondary battery has electrodes that swell and contract during charge and discharge. This causes stress to be applied to the nonaqueous electrolyte secondary battery separator. In this case, the porous film which is the nonaqueous electrolyte secondary battery separator and has isotropic deformation followability homogeneously deforms. This causes stress generated in the porous film in response to periodic electrode deformation during a charge and discharge cycle to be less anisotropic. This is considered to (i) make it less likely for, for example, falling-off of an electrode active material to occur, (ii) reduce an increase in internal resistance in the nonaqueous electrolyte secondary battery, and (iii) consequently allow the nonaqueous electrolyte secondary battery to have a higher cycle characteristic.

Furthermore, as estimated from the time-temperature superposition principle with regard to a process for relaxation of stress of a polymer, a frequency that is much lower than 10 Hz is obtained in a case where the dynamic viscoelasticity measurement carried out at a frequency of 10 Hz and a temperature of 90° C. is adapted to a case where a temperature in a range of approximately 20° C. to 60° C., at which temperature the nonaqueous electrolyte secondary battery operates, is regarded as a reference temperature. The obtained frequency is close to a time scale of electrode swelling and contraction that accompany a charge and discharge cycle of the nonaqueous electrolyte secondary battery. As such, the dynamic viscoelasticity measurement carried out at 10 Hz and 90° C. can be used to carry out a rheological evaluation corresponding to a time scale equivalent to a charge and discharge cycle in a temperature range in which a battery operates.

Anisotropy of tan δ is evaluated by use of a parameter X represented by the following Equation 1:

X=100×|MD tan δ−TD tan δ|/{(MD tan δ+TD tan δ)/2} (Equation 1)

where MD tan δ is tan δ in a machine direction (MD; flow direction) of the porous film, and TD tan δ is tan δ in a transverse direction (TD; width direction) of the porous film. According to an embodiment of the present invention, the parameter X has a value of not more than 20. As shown later in Examples, the parameter X which has such a value makes it possible to reduce an increase in internal resistance in the nonaqueous electrolyte secondary battery during a charge and discharge cycle.

The porous film preferably has a puncture strength of not less than 3 N. A too low puncture strength may result in tearing of the separator by anode and cathode active material particles and a short circuit in an anode and a cathode during, for example, (i) operations carried out during a battery assembly process, such as lamination and winding of (a) the anode and the cathode and (b) the separator and pressing of a group of rolls, or (ii) application of an external force to the battery. The porous film has a puncture strength preferably of not more than 10 N, and more preferably of not more than 8 N.

The porous film can have any thickness that is appropriately set in view of a thickness of a nonaqueous electrolyte secondary battery member of the nonaqueous electrolyte secondary battery. The porous film has a thickness preferably of 4 μm to 40 μm, more preferably of 5 μm to 30 μm, and still more preferably of 6 μm to 15 μm.

The porous film has a volume-based porosity that is preferably 20% to 80%, and more preferably 30% to 75%, in order to allow the non-aqueous secondary battery separator to (i) retain a larger amount of electrolyte solution and (ii) achieve a function of reliably preventing (shutting down) a flow of an excessively large current at a lower temperature. The porous film has pores having an average diameter (an average pore diameter) of preferably 0.3 μm or less, more preferably 0.14 μm or less, in order to, in a case where the porous film is used as a separator, achieve sufficient ion permeability and prevent particles from entering the cathode or the anode.

It is essential that the porous film contains a polyolefin component at a proportion of 50% by volume or more with respect to whole components contained in the porous film. Such a proportion of the polyolefin component is preferably 90% by volume or more, and more preferably 95% by volume or more. The porous film preferably contains, as the polyolefin component, a high molecular weight component having a weight-average molecular weight of 5×10⁵ to 15×10⁶. The porous film particularly preferably contains, as the polyolefin component, a polyolefin component having a weight-average molecular weight of 1,000,000 or more. This is because the porous film which contains such a polyolefin component allows the porous film and the entire nonaqueous electrolyte secondary battery separator to have a greater strength.

Examples of the polyolefin-based resin contained in the porous film include high molecular weight homopolymers or copolymers produced through polymerization of ethylene, propylene, 1-butene, 4-methyl-1-pentene, 1-hexene, and/or the like. The porous film can include a layer containing only one of these polyolefin-based resins and/or a layer containing two or more of these polyolefin-based resins. Among these, a high molecular weight polyethylene containing ethylene as a main component is particularly preferable. Note that the porous film can contain a non-polyolefin component, as long as the non-polyolefin component does not impair the function of the layer.

The porous film has normally an air permeability of in a range from 30 sec/100 cc to 500 sec/100 cc, and preferably in a range from 50 sec/100 cc to 300 sec/100 cc, in terms of Gurley values. A porous film having such an air permeability achieves sufficient ion permeability in a case where the porous film is used as a separator.

The porous film has a weight per unit area normally of 4 g/m² to 20 g/m², preferably of 4 g/m² to 12 g/m², and more preferably of 5 g/m² to 10 g/m². This is because such a weight per unit area of the porous film can increase (i) a strength, a thickness, handling easiness, and a weight of the porous film and (ii) a weight energy density and a volume energy density of a nonaqueous electrolyte secondary battery including the porous film as a nonaqueous electrolyte secondary battery separator.

The following description discusses a method for producing the porous film. The porous film which contains a poly olefin-based resin as a main component, e.g., the porous film which contains (i) ultra-high molecular weight polyolefin and (ii) a low molecular weight hydrocarbon having a weight-average molecular weight of not more than 10,000 is preferably produced by such a method as described below.

Specifically, the porous film can be obtained by a method including the steps of (1) obtaining a polyolefin resin composition by kneading (i) ultra-high molecular weight polyolefin (ii) a low molecular weight hydrocarbon having a weight-average molecular weight of not more than 10,000, and (iii) a pore forming agent, (2) forming (rolling) a sheet by using a reduction roller to roll the polyolefin resin composition obtained in the step (1), (3) removing the pore forming agent from the sheet obtained in the step (2), and (4) obtaining a porous film by stretching the sheet obtained in the step (3). Note that the stretching of the sheet in the step (4) can be carried out before the removal of the pore forming agent from the sheet in the step (3).

Note, however, that the porous film needs to be produced so that the parameter X, which indicates anisotropy of tan δ, has a value of not more than 20. A factor that, determines tan δ can be a crystal structure of a polymer. Detailed research has been carried out on a relationship between tan δ and a crystal structure of polyolefin, particularly of polyethylene (see Takayanagi M., J. of Macromol. Sci.-Phys., 3, 407-431 (1967); or Koubunshigakkai-hen [edited by the Society of Polymer Science], “Koubunshikagaku no Kiso [Fundamental Polymer Science],” 2nd. Ed., Tokyo Kagaku Dojin, 1994). According to these documents, a peak of tan δ of polyethylene which peak is observed at 0° C. to 130° C. belongs to crystal relaxation (α_{c} relaxation) and is viscoelastic crystal relaxation involved in an harmonicity of crystal lattice vibration. In a temperature range of the crystal relaxation, crystals are viscoelastic, and internal friction generated while a molecular chain is being stretched out from a lamellar crystal causes viscosity (loss elasticity). That is, it is considered that anisotropy of tan δ reflects not merely crystal anisotropy but rather anisotropy of internal friction generated while a molecular chain is being stretched out from a lamella. As such, by controlling a crystalline and amorphous distribution so that the distribution is made more uniform, it is possible to reduce anisotropy of tan δ and produce a porous film in which the parameter X has a value of not more than 20.

Specifically, in the step (1) (described earlier), two-stage preparation (two-stage mixing) is preferably carried out in which raw materials such as the ultra-high molecular weight polyolefin and the low molecular weight hydrocarbon are mixed first by use of, for example, a Henschel mixer (first stage mixing is carried out), and then mixing is carried out again by adding the pore forming agent to a resultant mixture obtained by the first stage mixing (second stage mixing is carried out). This may cause a phenomenon called gelation in which the pore forming agent and the low molecular weight hydrocarbon are uniformly coordinated around the ultra-high molecular weight polyolefin. A resin composition in which gelation has occurred allows uniform kneading of the ultra-high molecular weight polyolefin in a subsequent step and consequently facilitates uniform crystallization. This causes the crystalline and amorphous distribution to be more uniform, so that anisotropy of tan δ can be reduced. Note that in order to cause the porous film to contain an antioxidant, it is preferable to mix the antioxidant in the porous film during the first stage mixing.

In the first stage mixing, the ultra-high molecular weight polyolefin and the low molecular weight hydrocarbon are preferably uniformly mixed. It can be determined from, for example, an increase in bulk density of the mixture that the ultra-high molecular weight polyolefin and the low molecular weight hydrocarbon are uniformly mixed. Note that after the first stage mixing, the pore forming agent is preferably added at an interval of one or more minutes.

Note also that it can be determined from an increase in bulk density of the mixture that gelation has occurred during the mixing.

In the step (4) (described earlier), the porous film is preferably subjected to an annealing (heat fixation) treatment after the stretching. After the stretching, the porous film has (i) a region in which orientational crystallization has been caused by the stretching and (ii) the other amorphous region in which polyolefin molecules are entangled. The porous film which is subjected to the annealing treatment causes an amorphous part thereof to be reconstructed (clustered). This solves a problem of mechanical nonuniformity in a micro region of the porous film.

An annealing temperature, which is set in consideration of mobility of molecules of polyolefin to be used, is preferably not lower than (Tm−30° C.), more preferably not lower than (Tm−20° C.), and still more preferably not lower than (Tm−10° C.), where Tm is a melting point of the polyolefin (ultra-high molecular weight polyolefin) contained in the porous film after the stretching. A low annealing temperature prevents the reconstruction of the amorphous region from sufficiently progressing. This may cause a failure to solve the problem of mechanical nonuniformity. Meanwhile, the annealing temperature which exceeds Tm causes melting of the polyolefin and pore blockage in the porous film, so that the porous film cannot be annealed at such a temperature. Therefore, the annealing temperature is preferably lower than Tm. The melting point Tm of the polyolefin can be obtained by carrying out differential scanning calorimetry (DSC) with respect to the porous film.

The ultra-high molecular weight polyolefin is preferably in a powder form.

Examples of the low molecular weight hydrocarbon include low molecular weight polyolefin such as polyolefin wax and low molecular weight poly methylene such as Fischer-Tropsch wax. The low molecular weight polyolefin and the low molecular weight polymethylene each have a weight-average molecular weight preferably of not less than 200 and not more than 3,000. The low molecular weight hydrocarbon which has a weight-average molecular weight falling within the above range is preferable. This is because the low molecular weight hydrocarbon which has a weight-average molecular weight of not less than 200 has no fear of evaporation thereof during production of the porous film, and the low molecular weight hydrocarbon which has a weight-average molecular weight of not more than 3,000 can be more uniformly mixed with the ultra-high molecular weight polyolefin.

Examples of the pore forming agent include an inorganic filler, a plasticizer, and the like. The inorganic filler can be an inorganic filler that is soluble in an aqueous acidic solvent, an inorganic filler that is soluble an aqueous alkaline solvent, or an inorganic filler that is soluble an aqueous solvent mainly composed of water.

Examples of the inorganic filler that is soluble in an aqueous acidic solvent include calcium carbonate, magnesium carbonate, barium carbonate, zinc oxide, calcium oxide, aluminum hydroxide, magnesium hydroxide, calcium hydroxide, calcium sulfate, and the like. Of these inorganic fillers, calcium carbonate is preferable in terms of easiness to obtain a fine powder thereof at low cost. Examples of the inorganic filler that is soluble in an aqueous alkaline solvent include silicic acid and zinc oxide, and the like. Of these inorganic fillers, silicic acid is preferable in terms of easiness to obtain a fine powder thereof at low cost. Examples of the inorganic filler that is soluble in an aqueous solvent mainly composed of water include calcium chloride, sodium chloride, magnesium sulfate, and the like.

Examples of the plasticizer include nonvolatile hydrocarbon compounds each having a low molecular weight, such as liquid paraffin and mineral oil.

(1-2) Nonaqueous Electrolyte Secondary Battery Laminated Separator

According to another embodiment of the present invention, it is possible to use, as a separator, a nonaqueous electrolyte secondary battery laminated separator including (i) the nonaqueous electrolyte secondary battery separator, which is the porous film, and (ii) a porous layer. Since the porous film is as described earlier, the porous layer is described here.

The porous layer is appropriately laminated to one side or both sides of the nonaqueous electrolyte secondary battery separator, which is the porous film. It is preferable that a resin of which the porous layer is made be insoluble in an electrolyte of a battery and be electrochemically stable in a range of use of the battery. The porous layer that is laminated to one side of the porous film is preferably laminated to a surface of the porous film which surface faces a cathode of a nonaqueous electrolyte secondary battery which includes the laminated separator, and is more preferably laminated to a surface of the porous film which surface is in contact with the cathode.

Specific examples of the resin include: polyolefins such as polyethylene, polypropylene, polybutene, and an ethylene-propylene copolymer; fluorine-containing resins such as polyvinylidene fluoride (PVDF) and polytetrafluoroethylene; fluorine-containing rubbers such as a vinylidene fluoride-hexafluoropropylene copolymer, a tetrafluoroethylene-hexafluoropropylene copolymer, a tetrafluoroethylene-perfluoroalkyl vinyl ether copolymer, a vinylidene fluoride-tetrafluoroethylene copolymer, a vinylidene fluoride-tetrafluoroethylene copolymer, a vinylidene fluoride-trichloroethylene copolymer, a vinylidene fluoride-vinyl fluoride copolymer, a vinylidene fluoride-hexafluoropropylene-tetrafluoroethylene copolymer, and an ethylene-tetrafluoroethylene copolymer; aromatic polyamide; wholly aromatic polyamide (aramid resin); rubbers such as a styrene-butadiene copolymer and a hydride thereof, a methacrylate ester copolymer, an acrylonitrile-acrylic ester copolymer, a styrene-acrylic ester copolymer, ethylene propylene rubber, and polyvinyl acetate; resins having a melting point or a glass transition temperature of not less than 180° C., such as polyphenylene ether, polysulfone, polyether sulfone, polyphenylene sulfide, polyetherimide, polyamide-imide, polyether amide, and polyester; water-soluble polymers such as polyvinyl alcohol, polyethylene glycol, cellulose ether, sodium alginate, polyacrylic acid, polyacrylamide, and polymethacrylic acid; and the like.

Specific examples of the aromatic polyamide include poly(paraphenylene terephthalamide), poly(methaphenylene isophthalamide), poly(parabenzamide), poly(methabenzamide), poly(4,4′-benzanilide terephthalamide), poly(paraphenylene-4,4′-biphenylene dicarboxylic amide), poly(methaphenylene-4,4′-biphenylene dicarboxylic amide), poly(paraphenylene-2,6-naphthalene dicarboxylic-amide), poly(methaphenylene-2,6-naphthalene dicarboxylic amide), poly(2-chloroparaphenylene terephthalamide), a paraphenylene terephthalamide/2,6-dichloroparaphenylene terephthalamide copolymer, a methaphenylene terephthalamide/2,6-dichloroparaphenylene terephthalamide copolymer, and the like. Among these aromatic polyamides, poly(paraphenylene terephthalamide) is more preferable.

Among the above resins, fluorine-containing resins and aromatic poly amide are more preferable. Among the fluorine-containing resins, a polyvinylidene fluoride-based resin such as polyvinylidene fluoride (PVDF) or a copolymer of vinylidene fluoride (VDF) and hexafluoropropylene (HFP) is more preferable, and PVDF is still more preferable.

A porous layer containing a polyvinylidene fluoride-based resin is highly adhesive to an electrode and functions as an adhesive layer. A porous layer containing aromatic polyamide is highly heat-resistant and functions as a heat-resistant layer.

The porous layer can contain a filler, which is electrically insulating fine particles. Examples of the filler which can he contained in the porous layer include a filler made of an organic matter and a filler made of an inorganic matter. Specific examples of the filler made of an organic matter include fillers made of (i) a homopolymer of a monomer such as styrene, vinyl ketone, acrylonitrile, methyl methacrylate, ethyl methacrylate, glycidyl methacrylate, glycidyl acrylate, or methyl acrylate, or (ii) a copolymer of two or more of such monomers; fluorine-containing resins such as polytetrafluoroethylene, an ethylene tetrafluoride-propylene hexafluoride copolymer, a tetrafluoroethylene-ethylene copolymer, and polyvinylidene fluoride; melamine resin; urea resin; polyethylene; polypropylene; polyacrylic acid and polymethacrylic acid; and the like. Specific examples of the filler made of an inorganic matter include fillers made of inorganic matters such as calcium carbonate, talc, clay, kaolin, silica, hydrotalcite, diatomaceous earth, magnesium carbonate, barium carbonate, calcium sulfate, magnesium sulfate, barium sulfate, aluminum hydroxide, magnesium hydroxide, calcium oxide, magnesium oxide, titanium oxide, titanium nitride, alumina (aluminum oxide), aluminum nitride, mica, zeolite, and glass. The porous layer can contain (i) only one kind of filler or (ii) two or more kinds of fillers in combination.

Among the above fillers, a filler made of an inorganic matter, which filler is typically referred to as a filling material, is suitable. A filler made of an inorganic oxide such as silica, calcium oxide, magnesium oxide, titanium oxide, alumina, mica, or zeolite is preferable. A filler made of at least one kind selected from the group consisting of silica, magnesium oxide, titanium oxide, and alumina is more preferable. A filler made of alumina is particularly preferable. Alumina has many crystal forms such as α-alumina, β-alumina, γ-alumina, and θ-alumina, and any of the crystal forms can be suitably used. Among the above crystal forms, α-alumina, which is particularly high in thermal stability and chemical stability, is the most preferable.

The filler has a shape that varies depending on, for example, (i) a method for producing the organic matter or inorganic matter as a raw material and (ii) a condition under which the filler is dispersed during preparation of a coating solution for forming the porous layer. The filler can have any of various shapes such as a spherical shape, an oblong shape, a rectangular shape, a gourd shape, and an indefinite irregular shape.

In a case where the porous layer contains a filler, the filler is contained in an amount preferably of 1% by volume to 99% by volume and more preferably of 5% by volume to 95% by volume of the porous layer. The filler which is contained in the porous layer in an amount falling within the above range makes it less likely for a void formed by a contact among fillers to be blocked by, for example, a resin. This makes it possible to obtain sufficient ion permeability and to set a mass per unit area of the porous layer at an appropriate value.

According to an embodiment of the present invention, a coating solution for forming the porous layer is normally prepared by dissolving the resin in a solvent and dispersing the filler in a resultant solution.

The solvent (dispersion medium), which is not particularly limited to any specific solvent, only needs to (i) have no harmful influence on the porous film, (ii) uniformly and stably dissolve the resin, and (iii) uniformly and stably disperse the filler. Specific examples of the solvent (dispersion medium) include: water; lower alcohols such as methyl alcohol, ethyl alcohol, n-propyl alcohol, isopropyl alcohol, and t-butyl alcohol; acetone, toluene, xylene, hexane, N-methylpyrrolidone, N,N-dimethylacetamide, and N,N-dimethylformamide; and the like. The above solvents (dispersion media) can be used in only one kind or in combination of two or more kinds.

The coating solution can be formed by any method provided that the coating solution can meet conditions such as a resin solid content (resin concentration) and a filler amount each necessary for obtain merit of a desired porous layer. Specific examples of a method for forming the coating solution include a mechanical stirring method, an ultrasonic dispersion method, a high-pressure dispersion method, a media dispersion method, and the like.

Further, the filler can be dispersed in the solvent (dispersion medium) by use of, for example, a conventionally publicly known dispersing machine such as a three-one motor, a homogenizer, a media, dispersing machine, or a pressure dispersing machine.

In addition, the coating solution can contain, as a component different from the resin and the filler, additive(s) such as a disperser, a plasticizer, a surfactant, and/or a pH adjustor, provided that the additive(s) does/do not impair the object of the present invention. Note that the additive(s) can be contained in an amount that does not impair the object of the present invention.

A method for applying the coating solution to the separator, i.e., a method for forming the porous layer on a surface of the separator which has been appropriately subjected to a hydrophilization treatment is not particularly restricted. In a case where the porous layer is laminated to both sides of the separator, (i) a sequential lamination method in which the porous layer is formed on one side of the separator and then the porous layer is formed on the other side of the separator, or (ii) a simultaneous lamination method in which the porous layer is formed simultaneously on both sides of the separator is applicable to the case.

Examples of a method for forming the porous layer include: a method in which the coating solution is directly applied to the surface of the separator and then the solvent (dispersion medium) is removed; a method in which the coating solution is applied to an appropriate support, the porous layer is formed by removing the solvent (dispersion medium), and thereafter the porous layer thus formed and the separator are pressure-bonded and subsequently the support is peeled off; a method in which the coating solution is applied to the appropriate support and then the porous film is pressure-bonded to an application surface, and subsequently the support is peeled off and then the solvent (dispersion medium) is removed; a method in which the separator is immersed in the coating solution so as to be subjected to dip coating, and thereafter the solvent (dispersion medium) is removed; and the like.

The porous layer can have a thickness that is controlled by adjusting, for example, a thickness of a coated film that is moist (wet) after being coated, a weight ratio between the resin and the fine particles, and/or a solid content concentration fa sum of a resin concentration and a fine particle concentration) of the coating solution. Note that it is possible to use, as the support, a film made of resin, a belt made of metal, or a drum, for example.

A method for applying the coating solution to the separator or the support is not particularly limited to any specific method provided that the method achieves a necessary mass per unit area and a necessary coating area. The coating solution can be applied to the separator or the support by a conventionally publicly known method. Specific examples of the conventionally publicly known method include a gravure coater method, a small-diameter gravure coater method, a reverse roll coater method, a transfer roll coater method, a kiss coater method, a dip coater method, a knife coater method, an air doctor blade coater method, a blade coater method, a rod coater method, a squeeze coater method, a cast coater method, a bar coater method, a die coater method, a screen printing method, a spray application method, and the like.

Generally, the solvent (dispersion medium) is removed by drying. Examples of a drying method include natural drying, air-blowing drying, heat drying, vacuum drying, and the like. Note, however, that any drying method is usable provided that the drying method allows the solvent (dispersion medium) to be sufficiently removed. For the drying, it is possible to use an ordinary drying device.

Further, it is possible to carry out the drying after replacing, with another solvent, the solvent (dispersion medium) contained in the coating solution. Examples of a method for removing the solvent (dispersion medium) after replacing the solvent (dispersion medium) with another solvent include a method in which another solvent (hereinafter referred to as a solvent X) is used that is dissolved in the solvent (dispersion medium) contained in the coating solution and does not dissolve the resin contained in the coating solution, the separator or the support on which a coated film has been formed by application of the coating solution is immersed in the solvent X, the solvent (dispersion medium) contained in the coated film formed on the separator or the support is replaced with the solvent X, and thereafter the solvent X is evaporated. This method makes it possible to efficiently remove the solvent (dispersion medium) from the coating solution.

Assume that heating is carried out so as to remove the solvent (dispersion medium) or the solvent X from the coated film of the coating solution which coated film has been formed on the separator or the support. In this case, in order to prevent the separator from having a lower air permeability due to contraction of pores of the porous film, it is desirable to carry out heating at a temperature at which the separator does not have a lower air permeability, specifically, 10° C. to 120° C., more preferably 20° C. to 80° C.

In a case where the separator is used as the base material to form the laminated separator by laminating the porous layer to one side or both sides of the separator, the porous layer formed by the method described earlier has, per one side thereof, a film thickness preferably of 0.5 μm to 15 μm and more preferably of 2 μm to 10 μm.

The porous layer which has a film thickness of not less than 1 μm (not less than 0.5 μm per one side) makes it possible to sufficiently prevent an internal short circuit due to, for example, breakage of a battery in the nonaqueous electrolyte secondary battery laminated separator including the porous layer, and such a porous layer is preferable in that the porous layer makes it possible to maintain an amount of an electrolyte retained in the porous layer. Meanwhile, the porous layer whose both sides have a film thickness of not more than 30 μm in total (whose one side has a film thickness of not more than 15 μm) is preferable in that such a porous layer makes it possible to (i) prevent a deterioration, caused in a ease where charge and discharge cycles are repeated, in (a) cathode of a nonaqueous electrolyte secondary battery and (b) rate characteristic and/or cycle characteristic by preventing an increase in permeation resistance of ions such as lithium ions in the entire nonaqueous electrolyte secondary battery laminated separator including the porous layer, and (ii) prevent an increase in size of the nonaqueous electrolyte secondary battery by preventing an increase in distance between the cathode and an anode of the nonaqueous electrolyte secondary battery.

In a case where the porous layer is laminated to both sides of the porous film, physical properties of the porous layer which are described below at least refer to physical properties of the porous layer which is laminated to a surface of the porous film which surface faces the cathode of the nonaqueous electrolyte secondary battery which includes the laminated separator.

The porous layer, which only needs to have, per one side thereof, a mass per unit area which mass is appropriately determined in view of a strength, a film thickness, a weight, and handleability of the nonaqueous electrolyte secondary battery laminated separator, normally has a mass per unit area preferably of 1 g/m² to 20 g/m² and more preferably of 4 g/m² to 10 g/m² so that the nonaqueous electrolyte secondary battery which includes the nonaqueous electrolyte secondary battery laminated separator as a member can have a higher weight energy density and a higher volume energy density. The porous layer which has a mass per unit area which mass falls within the above range is preferable in that such a porous layer (i) allows the nonaqueous electrolyte secondary battery which includes, as a member, the nonaqueous electrolyte secondary battery laminated separator including the porous layer to have a higher weight energy density and a higher volume energy density, and (ii) allows the nonaqueous electrolyte secondary battery to have a lighter weight.

The porous layer has a porosity preferably of 20% by volume to 90% by volume and more preferably of 30% by volume to 70% by volume in that the nonaqueous electrolyte secondary battery laminated separator including such a porous layer can obtain sufficient ion permeability. Further, the porous layer has pores having a pore size preferably of not more than 1 μm and more preferably of not more than 0.5 μm in that the nonaqueous electrolyte secondary battery laminated separator including such a porous layer can obtain sufficient ion permeability.

The laminated separator has a Gurley air permeability preferably of 30 sec/100 mL to 1000 sec/100 mL and more preferably of 50 sec/100 mL to 800 sec/100 mL. The laminated separator which has a Gurley air permeability falling within the above range makes it possible to obtain sufficient ion permeability in a case where the laminated separator is used as a member for the nonaqueous electrolyte secondary battery.

Meanwhile, the laminated separator which has a Gurley air permeability beyond the above range means that the laminated separator has a coarse laminated structure due to a high porosity thereof. This causes the laminated separator to have a lower strength, so that the laminated separator may be insufficient in shape stability, particularly shape stability at a high temperature. In contrast, the laminated separator which has a Gurley air permeability falling below the above range makes it impossible to obtain sufficient ion permeability in a case where the separator is used as a member for the nonaqueous electrolyte secondary battery. This may cause the nonaqueous electrolyte secondary battery to have a lower battery characteristic.

[2. Nonaqueous Electrolyte Secondary Battery Member, Nonaqueous Electrolyte Secondary Battery]

A nonaqueous electrolyte secondary battery member in accordance with an embodiment of the present invention is a nonaqueous electrolyte secondary battery member including a cathode, a nonaqueous electrolyte secondary battery separator or a nonaqueous electrolyte secondary battery laminated separator, and an anode that are provided in this order. A nonaqueous electrolyte secondary battery in accordance with an embodiment of the present invention includes a nonaqueous electrolyte secondary battery separator or a nonaqueous electrolyte secondary battery laminated separator. The following description is given by (i) taking a lithium ion secondary battery member as an example of the nonaqueous electrolyte secondary battery member and (ii) taking a lithium ion secondary battery as an example of the nonaqueous electrolyte secondary battery. Note that components of the nonaqueous electrolyte secondary battery member or the nonaqueous electrolyte secondary battery except the nonaqueous electrolyte secondary battery separator or the nonaqueous electrolyte secondary battery laminated separator are not limited to those discussed in the following description.

In the nonaqueous electrolyte secondary battery in accordance with an embodiment of the present invention, it is possible to use, for example, a nonaqueous electrolyte obtained by dissolving lithium salt in an organic solvent. Examples of the lithium salt include LiClO₄, LiPF₆, LiAsF₆, LiSbF₆, LiBF₄, LiCF₃SO₃, LiN(CF₃SO₂)₂, LiC(CF₃SO₂)₃, Li₂B₁₀Cl₁₀, lower aliphatic carboxylic acid lithium salt, LiAlCl₄, and the like. The above lithium salts can be used in only one kind or in combination of two or more kinds. Of the above lithium salts, at least one kind of fluorine-containing Lithium salt selected from the group consisting of LiPF₆, LiAsF₆, LiSbF₆, LiBF₄, LiCF₃SO₃, LiN(CF₃SO₂)₂, and LiC(CF₃SO₂)₃ is more preferable.

Specific examples of the organic solvent of the nonaqueous electrolyte include: carbonates such as ethylene carbonate, propylene carbonate, dimethyl carbonate, diethyl carbonate, ethyl methyl carbonate, 4-trifluoromethyl-1,3-dioxolane-2-one, and 1,2-dimethoxycarbonyloxy)ethane; ethers such as 1,2-dimethoxyethane, 1,3-dimethoxypropane, pentafluoropropylmethylmethyl ether, 2,2,3,3-tetrafluoropropyldifluoromethyl ether, tetrahydrofuran, and 2-methyltetrahydrofuran; esters such as methyl formate, methyl acetate, and γ-butyrolactone; nitrites such as acetonitrile and butyronitrile; amides such as N,N-dimethylformamide and N,N-dimethylacetamide; carbamates such as 3-methyl-2-oxazolidone; sulfur-containing compounds such as sulfolane, dimethylsulfoxide, and 1,3-propanesultone; a fluorine-containing organic solvent obtained by introducing a fluorine group in the organic solvent; and the like. The above organic solvents can be used in only one kind or in combination of two or more kinds. Of the above organic solvents, a carbonate is more preferable, and a mixed solvent of cyclic carbonate and acyclic carbonate or a mixed solvent of cyclic carbonate and an ether is more preferable. The mixed solvent of cyclic carbonate and acyclic carbonate is more preferably exemplified by a mixed solvent containing ethylene carbonate, dimethyl carbonate, and ethyl methyl carbonate. This is because the mixed solvent containing ethylene carbonate, dimethyl carbonate, and ethyl methyl carbonate operates in a wide temperature range, and is refractory also in a case where a graphite material such as natural graphite or artificial graphite is used as an anode active material.

Normally, a sheet cathode in which a cathode current collector supports thereon a cathode mix containing a cathode active material, an electrically conductive material, and a binding agent is used as the cathode.

Examples of the cathode active material include a material that is capable of doping and dedoping lithium ions. Specific examples of such a material include lithium, complex oxides each containing at least one kind of transition metal selected from the group consisting of V, Mn, Fe, Co, and Ni. Of the above lithium complex oxides, a lithium complex oxide having an α-NaFeO₂ structure, such as lithium nickel oxide or lithium cobalt oxide, or a lithium complex oxide having a, spinel structure, such as lithium manganate spinel is more preferable. This is because such a lithium complex oxide is high in average discharge potential. The lithium complex oxide can contain, various metallic elements, and lithium nickel complex oxide is more preferable. Further, it is particularly preferable to use lithium nickel complex oxide which contains at least one kind of metallic element so that the at least one kind of metallic element accounts for 0.1 mol % to 20 mol % of a sum of the number of moles of the at least one kind of metallic element and the number of moles of Ni in lithium, nickel oxide, the at least one kind of metallic element being selected from the group consisting of Ti, Zr, Ce, Y, V, Cr, Mn, Fe, Co, Cu, Ag, Mg, Al, Ga, In, and Sn. This is because such lithium nickel complex oxide is excellent in cycle characteristic during use of the nonaqueous electrolyte secondary battery at a high capacity. Especially an active material which contains Al or Mn and has an Ni content of not less than 85% and more preferably of not less than 90% is particularly preferable. This is because such an active material is excellent in cycle characteristic during use of the nonaqueous electrolyte secondary battery at a high capacity, the nonaqueous electrolyte secondary battery including the cathode containing the active material.

Examples of the electrically conductive material include carbonaceous materials such as natural graphite, artificial graphite, cokes, carbon black, pyrolytic carbons, carbon fiber, organic high molecular compound baked bodies, and the like. The above electrically conductive materials can be used in only one kind. Alternatively, the above electrically conductive materials can be used in combination of two or more kinds by, for example, mixed use of artificial graphite and carbon black.

Examples of the binding agent include polyvinylidene fluoride, a vinylidene fluoride copolymer, polytetrafluoroethylene, a vinylidene fluoride-hexafluoropropylene copolymer, a tetrafluoroethylene-hexafluoropropylene copolymer, a terafluoroethylene-perfluoroalkyl vinyl ether copolymer, an ethylene-tetrafluroethylene copolymer, a vinylidene fluoride-tetrafluoroethylene copolymer, a vinylidene fluoride-trifluoroethylene copolymer, and a vinylidene fluoride-trichloroethylene copolymer, and a vinylidene fluoride-vinyl fluoride copolymer, a vinylidene fluoride-hexafluoropropylene-tetrafluoroethylene copolymer, thermoplastic resins such as thermoplastic polyimide, thermoplastic polyethylene, and thermoplastic polypropylene, acrylic resin, and styrene butadiene rubber. Note that the binding agent also functions as a thickener.

The cathode mix can be obtained by, for example, pressing the cathode active material, the electrically conductive material, and the binding agent on the cathode current collector, or causing the cathode active material, the electrically conductive material, and the binding agent to be in a form of paste by use of an appropriate organic solvent.

Examples of the cathode current collector include electrically conductive materials such as Al, Ni, and stainless steel, and Al, which is easy to process into a thin film and less expensive, is more preferable.

Examples of a method for producing the sheet cathode, i.e., a method for causing the cathode current collector to support the cathode mix include: a method in which the cathode active material, the electrically conductive material, and the binding agent which are to be formed into the cathode mix are pressure-molded on the cathode current collector; a method in which the cathode current collector is coated with the cathode mix which has been obtained by causing the cathode active material, the electrically conductive material, and the binding agent to be in a form of paste by use of an appropriate organic solvent, and a sheet cathode mix obtained by drying is pressed so as to be closely fixed to the cathode current collector; and the like.

Normally, a sheet anode in which an anode current collector supports thereon an anode mix containing an anode active material is used as the anode. The sheet anode preferably contains the electrically conductive material and the binding agent.

Examples of the anode active material include a material that is capable of doping and dedoping lithium ions, lithium metal or lithium alloy, and the like. Specific examples of such a material include: carbonaceous materials such as natural graphite, artificial graphite, cokes, carbon black, pyrolytic carbons, carbon fiber, and organic high molecular compound baked bodies; chalcogen compounds such as oxides and sulfides each doping and dedoping lithium ions at a lower potential than that of the cathode; metals such as aluminum (Al), lead (Pb), tin (Sn), bismuth (Bi), and silicon (Si) each alloyed with an alkali metal; cubic intermetallic compounds (AlSb, Mg₂Si, NiSi₂) having lattice spaces in which alkali metals can be provided; lithium nitrogen compounds (Li₃₋ₓMₓN (M: transition metal)); and the like. Of the above anode active materials, a carbonaceous material which contains, as a main component, a graphite material such as natural graphite or artificial graphite is preferable. This is because such a carbonaceous material is high in potential evenness, and a great energy density can be obtained in a case where the carbonaceous material, which is low in average discharge potential, is combined with the cathode. An anode active material which is a mixture of graphite and silicon and has an Si to C ratio of not less than 5% is more preferable, and an anode active material which is a mixture of graphite and silicon and has an Si to C ratio of not less than 10% is still more preferable.

The anode mix can he obtained by, for example, pressing the anode active material on the anode current collector, or causing the anode active material to he in a form of paste by use of an appropriate organic solvent.

Examples of the anode current collector include Cu, Ni, stainless steel, and the like, and Cu, which is difficult to alloy with lithium particularly in a lithium ion secondary battery and easy to process into a thin film, is more preferable.

Examples of a method for producing the sheet anode, i.e., a method for causing the anode current collector to support the anode mix include: a method in which the anode active material to be formed into the anode mix is pressure-molded on the anode current collector; a method in which the anode current collector is coated with the anode mix which has been obtained by causing the anode active material to be in a form of paste by use of an appropriate organic solvent, and a sheet anode mix obtained by drying is pressed so as to be closely fixed to the anode current collector; and the like. The paste preferably contains the electrically conductive material and the binding agent.

The nonaqueous electrolyte secondary battery member in accordance with an embodiment of the present invention is formed by providing the cathode, the nonaqueous electrolyte secondary battery separator or the nonaqueous electrolyte secondary battery laminated separator, and the anode in this order. Thereafter, the nonaqueous electrolyte secondary battery member is placed in a container serving as a housing of the nonaqueous electrolyte secondary battery. Subsequently, the container is filled with a nonaqueous electrolyte, and then the container is sealed while being decompressed. The nonaqueous electrolyte secondary battery in accordance with an embodiment of the present invention can thus be produced. The nonaqueous electrolyte secondary battery, which is not particularly limited in shape, can have any shape such as a sheet (paper) shape, a disc shape, a cylindrical shape, or a prismatic shape such as a rectangular prismatic shape. Note that a method for producing the nonaqueous electrolyte secondary battery is not particularly limited to any specific method, and a conventionally publicly known production method can be employed as the method.

### EXAMPLES

<Method for Measuring Various Physical Properties>

Various physical properties of nonaqueous electrolyte secondary battery separators in accordance with the following Examples and Comparative Examples were measured by the method below.

(1) Untamped Density of Resin Composition

An untamped density of a resin composition used to produce a porous film was measured in conformity with JIS R9301-2-3.

(2) Dynamic Viscoelasticity

Dynamic viscoelasticity of a nonaqueous electrolyte secondary battery separator was measured by use of a dynamic viscoelasticity measurement device (itk DVA-225, manufactured by ITK Co., Ltd.) at a frequency of 10 Hz and a temperature of 90° C.

Specifically, a test piece which had been cut out from a porous film, used as the nonaqueous electrolyte secondary battery separator, so as to be strip-shaped and which had a width of 5 mm assuming that MD was a longer side direction was used to measure tan δ in MD while a chuck-to-chuck distance was set at 20 mm and a tension of 30 cN was applied to the test piece. Similarly, a test piece which bad been cut out from the porous film so as to be strip-shaped and which had a width of 5 mm assuming that TD was a longer side direction was used to measure tan δ in TD while a chuck-to-chuck distance was set at 20 mm and a tension of 30 cN was applied to the test piece. The measurement was carried out at a temperature that was increased from a room temperature at a rate of 20° C./min. The parameter X was calculated by use of tan δ obtained when the temperature reached 90° C.

(3) Puncture Strength

Maximum stress (gf) obtained in a ease where a nonaqueous electrolyte secondary battery separator was fixed by use of a washer having a diameter of 12 mm and then was punctured with a pin at 200 mm/min was regarded as a puncture strength of the nonaqueous electrolyte secondary battery separator. The pin had a diameter of 1 mm and a tip having 0.5 R.

(4) Measurement of Melting Point of Porous Film

Approximately 50 mg of a nonaqueous electrolyte secondary battery separator was placed in an aluminum pan, and then a DSC thermogram was obtained by use of a differential scanning calorimeter (EXSTAR6000, manufactured by Seiko Instruments) at a temperature that was increased at a rate of 20° C./min, and a peak temperature of a melting peak around 140° C. was assumed as Tm.

(5) Rate of Increase in Internal Resistance Through Charge and Discharge Cycle

Nonaqueous electrolyte secondary batteries each assembled as described later were each subjected to four cycles of initial charge and discharge. Each of the four cycles of the initial charge and discharge was carried out at 25° C., at a voltage ranging from 4.1 V to 2.7 V, and at an electric current value of 0.2 C. Note that a value of an electric current at which a battery rated capacity defined as a one-hour rate discharge capacity is discharged in one hour is assumed to be 1 C. This applies also to the following descriptions.

Subsequently, an alternating current impedance of a nonaqueous electrolyte secondary battery, which, had been subjected to the initial charge and discharge, was measured by use of an LCR meter (chemical impedance meter, type 3532-80, manufactured by Hioki E. E. Corporation) at a room temperature of 25° C. while a voltage amplitude of 10 mV was applied to the nonaqueous electrolyte secondary battery.

Results of the measurement were used to read (i) an equivalent series resistance (Rs1: Ω) at a frequency of 10 Hz and (ii) an equivalent series resistance (Rs2: Ω) at a reactance of 0 so as to calculate a resistance (R1: Ω), which was a difference between (i) and (ii), based on the following equation:

R1 (Ω)=Rs1−Rs2

where Rs1 mainly indicates a sum of a resistance occurring when Li³⁰ ions pass through the nonaqueous electrolyte secondary battery separator (solution resistance), a conductive resistance within a cathode of the nonaqueous electrolyte secondary battery, and an ionic resistance occurring when ions move through an interface between the cathode and an electrolyte solution, and Rs2 mainly indicates the solution resistance. As such, R1 indicates a sum of the conductive resistance within the cathode and the ionic resistance occurring when the ions move through the interface between the cathode and the electrolyte solution.

The nonaqueous electrolyte secondary batteries, which had been subjected to the measurement of R1, were each subjected to a charge and discharge cycle test in which 100 cycles of charge and discharge were carried out. Each of the 100 cycles of the charge and discharge was carried out at 55° C., at a voltage ranging from 4.2 V to 2.7 V, and at a constant charge electric current value of 1 C and a constant, discharge electric current value of 10 C.

Subsequently, an alternating current impedance of a nonaqueous electrolyte secondary battery, which had been subjected to the charge and discharge cycle test, was measured by use of the LCR meter (chemical impedance meter, type 3532-80, manufactured by Hioki E. E. Corporation) at a room temperature of 25° C. while a voltage amplitude of 10 mV was applied to the nonaqueous electrolyte secondary battery.

As in the case of R1, results of the measurement were used to read (i) an equivalent series resistance (Rs3: Ω) at a frequency of 10 Hz and (ii) an equivalent series resistance (Rs4: Ω) at a reactance of 0 so as to calculate a resistance (R2: Ω), which was a sum of (i) a conductive resistance within the cathode of the nonaqueous electrolyte secondary battery after 100 cycles and (ii) an ionic resistance occurring when the ions move through the interface between the cathode and the electrolyte solution, based on the following equation:

R2 (Ω)=Rs3−Rs4

Next, the rate of increase in internal resistance through the charge and discharge cycle was calculated based on the following equation:

Rate of increase (%) in internal resistance through charge and discharge cycle=R2/R1×100

<Production of Nonaqueous Electrolyte Secondary Battery Separator>

As described below, porous films which are used as nonaqueous secondary battery separators were produced as porous films in accordance with Examples 1 through 3 and Comparative Examples 1 and 2.

### Example 1

First, 68% by weight of an ultra-high molecular weight polyethylene powder (GUR2024, manufactured by Ticona) and 32% by weight of a polyethylene wax (FNP-0115, manufactured by Nippon Seiro Co., Ltd.) that had a weight-average molecular weight of 1000 were prepared, i.e., 100 parts by weight in total of the ultra-high molecular weight polyethylene and the polyethylene wax were prepared. Then, 0.4% by weight of an antioxidant (Irg1010, manufactured by Ciba Specialty Chemicals), 0.1% by weight of an antioxidant (P168, manufactured by Ciba Specialty Chemicals), and 1.3% by weight of sodium stearate were added to the ultra-high molecular weight polyethylene and the polyethylene wax. Then, these compounds were mixed in a state of powder by a Henschel mixer at 440 rpm for 70 seconds. Next, calcium carbonate (manufactured by Maruo Calcium Co., Ltd.) having an average particle size of 0.1 μm was further added by 38% by volume with respect to a total volume of these compounds, and further mixing was carried out by use of the Henschel mixer at 440 rpm for 80 seconds. A resultant mixture, which was in a powder form, had an untamped density of 500 g/L. The compounds were then melted and kneaded by a twin screw kneading extruder and thus a poly olefin resin composition was obtained. Then, the polyolefin resin composition was rolled by a pair of rollers having a surface temperature of 150° C., so that a sheet was produced. The sheet thus produced was immersed in a hydrochloric acid aqueous solution (4 mol/L of hydrochloric acid, 0.5% by weight of a nonionic surfactant), so that calcium carbonate was removed. Then, the sheet was stretched at a stretching ratio of 6.2 times in TD at 100° C. Thereafter, the sheet was annealed at 126° C. (8° C. lower than 134° C., which is a melting point of the polyolefin resin contained in the sheet), so that the porous film of Example 1 was obtained.

### Example 2

First, 68.5% by weight of an ultra-high molecular weight polyethylene powder (GUR4032, manufactured by Ticona) and 31.5% by weight, of a polyethylene wax (FNP-0115, manufactured by Nippon Seiro Co., Ltd.) that had a weight-average molecular weight of 1000 were prepared, i.e., 100 parts by weight in total of the ultra-high molecular weight polyethylene and the polyethylene wax were prepared. Then, 0.4% by weight of an antioxidant (Irg1010, manufactured by Ciba Specialty Chemicals), 0.1% by weight of an antioxidant (P168, manufactured by Ciba Specialty Chemicals), and 1.3% by weight of sodium stearate were added to the ultra-high molecular weight polyethylene and the polyethylene wax. Then, these compounds were mixed in a state of powder by a Henschel mixer at 440 rpm for 70 seconds. Next, calcium carbonate (manufactured by Maruo Calcium Co., Ltd.) having an average particle size of 0.1 μm was further added by 38% by volume with respect to a total volume of these compounds, and further mixing was carried out by use of the Henschel mixer at 440 rpm for 80 seconds. A resultant mixture, which was in a powder form, had an untamped density of 500 g/L. The compounds were then melted and kneaded by a twin screw kneading extruder and thus a polyolefin resin composition was obtained. Then, the polyolefin resin composition was rolled by a pair of rollers having a surface temperature of 150° C. so that a sheet was produced. The sheet thus produced was immersed in a hydrochloric acid aqueous solution (4 mol/L of hydrochloric acid, 0.5% by weight of a nonionic surfactant), so that calcium carbonate was removed. Then, the sheet was stretched at a stretching ratio of 7.0 times in TD at 100° C. Thereafter, the sheet was annealed at 123° C. (10° C. lower than 133° C., which is a melting point the polyolefin resin contained in the sheet) so that the porous film of Example 2 was obtained.

### Example 3

First, 70% by weight of an ultra-high molecular weight polyethylene powder (GUR4032, manufactured by Ticona) and 30% by weight of a polyethylene wax (FNP-0115, manufactured by Nippon Seiro Co., Ltd.) that had a weight-average molecular weight of 1000 were prepared, i.e., 100 parts by weight in total of the ultra-high molecular weight polyethylene and the polyethylene wax were prepared. Then, 0.4% by weight of an antioxidant (Irg1010, manufactured by Ciba Specialty Chemicals), 0.1% by weight of an antioxidant (P168, manufactured by Ciba Specialty Chemicals), and 1.3% by weight of sodium stearate were added to the ultra-high molecular weight polyethylene and the polyethylene wax. Then, these compounds were mixed in a state of powder by a Henschel mixer at 440 rpm for 70 seconds. Next, calcium carbonate (manufactured by Maruo Calcium Co., Ltd.) having an average particle size of 0.1 μm was further added by 38% by volume with respect to a total volume of these compounds, and further mixing was carried out by use of the Henschel mixer at 440 rpm for 80 seconds, A resultant mixture, which was in a powder form, had an untamped density of 500 g/L. The compounds were then melted and kneaded fay a twin screw kneading extruder and thus a polyolefin resin composition was obtained. Then, the polyolefin resin composition was rolled by a pair of rollers having a surface temperature of 150° C. so that a sheet was produced. The sheet thus produced was immersed in a hydrochloric acid aqueous solution (4 mol/L of hydrochloric acid, 0.5% by weight of a nonionic surfactant), so that calcium carbonate was removed. Then, the sheet was stretched at a stretching ratio of 6.2 times in TD at 100° C. Thereafter, the sheet was annealed at 120° C. (13° C. lower than 133° C., which is a melting point the polyolefin resin contained in the sheet) so that the porous film of Example 3 was obtained.

### Comparative Example

First, 70% by weight of an ultra-high molecular weight polyethylene powder (GUR4032, manufactured by Ticona) and 30% by weight of a polyethylene wax (FNP-0115, manufactured by Nippon Seiro Co., Ltd.) that had a weight-average molecular weight of 1000 were prepared, i.e., 100 parts by weight in total of the ultra-high molecular weight polyethylene and the polyethylene wax were prepared. Then, 0.4% by weight of an antioxidant (Irg1010, manufactured by Ciba Specialty Chemicals), 0.1% by weight of an antioxidant (P168, manufactured by Ciba Specialty Chemicals), and 1.3% by weight of sodium stearate were added to the ultra-high molecular weight polyethylene and the polyethylene wax, and, simultaneously, calcium carbonate (manufactured by Maruo Calcium Co., Ltd,) having an average particle size of 0.1 μm was further added by 38% by volume with respect to a total volume of these compounds. Then, these compounds were mixed by a Henschel mixer at 440 rpm for 150 seconds. A resultant mixture, which was in a powder form, had an untamped density of 350 g/L. The compounds were then melted and kneaded by a twin screw kneading extruder and thus a polyolefin resin composition was obtained. Then, the polyolefin resin composition was rolled by a pair of rollers having a surface temperature of 150° C. so that a sheet was produced. The sheet thus produced was immersed in a hydrochloric acid aqueous solution (4 mol/L of hydrochloric acid, 0.5% by weight of a nonionic surfactant), so that calcium carbonate was removed. Then, the sheet was stretched at a stretching ratio of 6.2 times in TD at 100° C. Thereafter, the sheet was annealed at 115° C. (18° C. lower than 133° C., which is a melting point the polyolefin resin contained in the sheet) so that the porous film of Comparative Example 1 was obtained.

### Comparative Example 2

First, 80% by weight, of an ultra-high molecular -weight polyethylene powder (GUR4032, manufactured by Ticona) and 20% by weight of a polyethylene wax (FNP-0115, manufactured by Nippon Seiro Co., Ltd.) that had a weight-average molecular weight of 1000 were prepared, i.e., 100 parts by weight in total of the ultra-high molecular weight polyethylene and the polyethylene wax were prepared. Then, 0.4% by weight of an antioxidant (Irg1010, manufactured by Ciba Specialty Chemicals), 0.1% by weight of an antioxidant (P168, manufactured by Ciba Specialty Chemicals), and 1.3% by weight of sodium a stearate were added to the ultra-high molecular weight polyethylene and the polyethylene wax, and, simultaneously, calcium carbonate (manufactured by Maruo Calcium Co., Ltd.) having an average particle size of 0.1 μm was further added by 38% by volume with respect to a total volume of these compounds. Then, these compounds were mixed by a Henschel mixer at 440 rpm for 150 seconds. A resultant mixture, which was in a powder form, had an untamped density of 350 g/L. The compounds were then melted and kneaded by a twin screw kneading extruder and thus a polyolefin resin composition was obtained. Then, the polyolefin resin composition was rolled by a pair of rollers having a surface temperature of 150° C. so that a sheet was produced. The sheet thus produced was immersed in a hydrochloric acid aqueous solution (4 mol/L of hydrochloric acid, 0.5% by weight of a nonionic surfactant), so that calcium carbonate was removed. Then, the sheet was stretched at a stretching ratio of 4.0 times in TD at 105° C. Thereafter, the sheet was annealed at 120° C. (12° C. lower than 132° C., which is a melting point the polyolefin resin contained in the sheet) so that the porous film of Comparative Example 2 was obtained.

### Comparative Example 3

A commercially available polyolefin separator (porous film) was used as a nonaqueous electrolyte secondary battery separator of Comparative Example 3.

<Production of Nonaqueous Electrolyte Secondary Battery>

Next, nonaqueous secondary batteries were produced as below, by using the nonaqueous secondary battery separators of Examples 1 through 3 and Comparative Examples 1 through 3, which were produced as above.

(Cathode)

A commercially available cathode which was produced by applying LiNi_{0.5}Mn_{0.3}Co_{0.2}O₂/conductive material/PVDF (weight ratio 92/5/3) to an aluminum foil was used. The aluminum foil of the cathode was cut so that a portion of the cathode where a cathode active material layer was formed had a size of 45 mm×30 mm and a portion where the cathode active material layer was not formed, with a width of 13 mm, remained around that portion. The cathode active material layer had a thickness of 58 μm and density of 2.50 g/cm³. The cathode had a capacity of 174 mAh/g.

(Anode)

A commercially available anode produced by applying graphite/styrene-1,3-butadiene copolymer/carboxymethyl cellulose sodium (weight ratio 98/1/1) to a copper foil was used. The copper foil of the anode was cut so that a portion of the anode where an anode active material layer was formed had a size of 50 mm×35 mm, and a portion where the anode active material layer was not formed, with a width of 13 mm, remained around that portion. The anode active material layer had a thickness of 49 μm and density of 1.40 g/cm³. The anode had a capacity of 372 mAh/g.

(Assembly)

In a laminate pouch, the cathode, the nonaqueous secondary battery separator, and the anode were laminated (provided) in this order so as to obtain a nonaqueous electrolyte secondary battery member. In this case, the cathode and the anode were positioned so that a whole of a main surface of the cathode active material layer of the cathode was included in a range of a main surface (overlapped the main surface) of the anode active material layer of the anode.

Subsequently, the nonaqueous electrolyte secondary battery member was put in a bag made by laminating an aluminum layer and a heat seal layer, and 0.25 ml of a nonaqueous electrolyte solution was poured into the bag. The nonaqueous electrolyte solution was an electrolyte solution at 25° C. obtained by dissolving LiPF₆ with a concentration of 1.0 mole per liter in a mixed solvent of ethyl methyl carbonate, diethyl carbonate, and ethylene carbonate in a volume ratio of 50:20:30. The bag was heat-sealed while a pressure inside the bag was reduced, so that a nonaqueous secondary battery was produced. The nonaqueous electrolyte secondary battery had a design capacity of 20.5 mAh.

<Results of Measurement of Various Physical Properties>

Table 1 shows the results of measurement of various physical properties for each of the nonaqueous electrolyte secondary battery separators of Examples 1 through 3 and Comparative Examples 1 through 3.

TABLE 1

| | Untamped | | | | | |
|---|---|---|---|---|---|---|
| | density | | | | Rate of | |
| | of resin | | Anneal- | | increase | |
| | composi- | Stretch- | ing | Para- | in internal | Puncture |
| | tion | ing | temp.*³ | meter | resistance | strength |
| | (g/L) | ratio | (° C.) | X | (%) | (N) |
| Ex.*¹ | 500 | 6.2 | 126 | 6.9 | 233 | 4.18 |
| 1 | | | | | | |
| Ex. 2 | 500 | 7.0 | 123 | 2.3 | 233 | 3.40 |
| Ex. 3 | 500 | 6.2 | 120 | 15.8 | 257 | 3.55 |
| Com.*² | 350 | 6.2 | 115 | 21.9 | 300 | 2.56 |
| Ex. 1 | | | | | | |
| Com. | 350 | 4.0 | 120 | 25.9 | 308 | 3.07 |
| Ex. 2 | | | | | | |

| | | | | |
|---|---|---|---|---|
| Com. | Unknown due to being a | 72.1 | 416 | 3.40 |
| Ex. 3 | commercial product | | | |

*¹“Ex. is an abbreviation for “Example”.
*²“Com. Ex.” is an abbreviation for “Comparative Example”.
*³“temp.” is an abbreviation for “temperature”.

As shown in Table 1, the polyolefin resin compositions of which the nonaqueous electrolyte secondary battery separators of Examples 1 through 3 were made each had a high untamped density of 500 g/L. This seems to be because of the following reason. Specifically, since ultra high molecular weight polyethylene powder, polyethylene wax, and an antioxidant were uniformly mixed first and then mixing was carried out again by adding calcium carbonate to a resultant mixture, gelation occurred in which the calcium carbonate, low molecular weight polyolefin, and the antioxidant were uniformly coordinated around the ultra-high molecular weight polyethylene powder. In contrast, the resin compositions of Comparative Examples 1 and 2, in which all raw materials, including calcium carbonate, in a powder form were simultaneously mixed and thus no gelation occurred, each had a low untamped density of 350 g/L.

Furthermore, according to Examples 1 through 3, since the sheets formed from the resin compositions, whose materials were uniformly dispersed by gelation, were stretched and then annealed, uniformly dispersed polyethylene crystals were isotropically developed at a micro level so as to be more uniform. This reveals that the nonaqueous electrolyte secondary battery separators of Examples 1 through 3 each had a parameter X whose value was not more than 20, the parameter X Indicating anisotropy of tan δ.

In contrast, according to Comparative Examples 1 and 2, in which no gelation occurred, though the sheets were annealed, polyethylene crystals were insufficiently made uniform at a micro level, and the nonaqueous electrolyte secondary battery separators of Comparative Examples 1 and 2 each had a parameter X whose value exceeded 20, the parameter X indicating anisotropy of tan δ. Furthermore, the commercially available nonaqueous electrolyte secondary battery separator of Comparative Example 3 also had the parameter X whose value greatly exceeded 20.

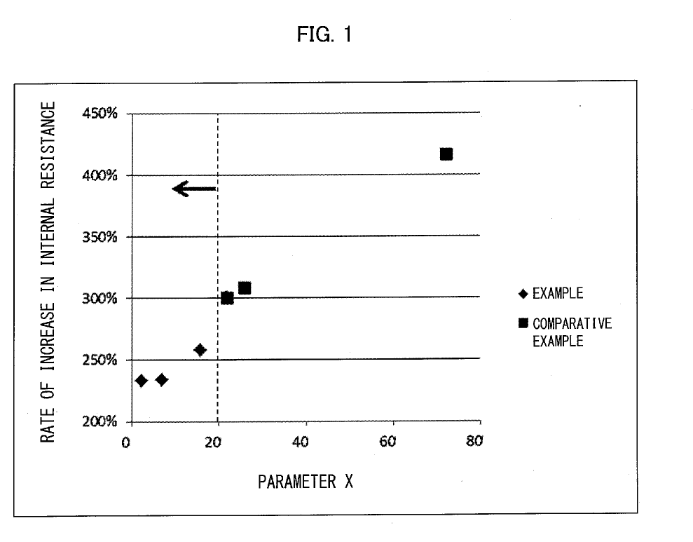

FIG. 1 is a graph on which a relationship between a parameter X and a rate of increase in internal resistance in each of Examples 1 through 3 and Comparative Examples 1 through 3 is plotted. As shown in FIG. 1, a parameter X of 20 serves as a point at which the internal resistance greatly changes. According to each of Examples 1 through 3, in each of which a parameter X of not more than 20 was obtained, a rate of increase in internal resistance through the charge and discharge cycle test was kept under 300%. This reveals that Examples 1 through 3 yield results superior to those yielded by Comparative Examples 1 through 3. A nonaqueous electrolyte secondary battery separator which has a small amount of anisotropy of tan δ homogeneously deforms in response to swelling and contraction of electrodes during a charge and discharge cycle test. This causes stress generated in the nonaqueous electrolyte secondary battery separator to have a small amount of anisotropy. Thus, it is considered that since an electrode active material, for example is less likely to fall off, a rate of increase in internal resistance is reduced.

Furthermore, it is revealed that the nonaqueous electrolyte secondary battery separators of Examples 1 through 3 each had a puncture strength of not less than 3 N, which is equal to or more than a puncture strength of the commercially available nonaqueous electrolyte secondary battery separator of Comparative Example 3.

1.-13. (canceled)

14. A method for producing a nonaqueous electrolyte secondary battery separator comprising a porous film containing a polyolefin as a main component,
the method comprising the steps of:
(i) uniformly mixing an ultra-high molecular weight polyethylene and a low molecular weight hydrocarbon to form a first mixture; p1 (ii) one or more minutes after completing step (i), mixing a pore forming agent and the first mixture to form a second mixture;
(iii) forming the second mixture into a sheet;
(iv) obtaining the porous film by removing the pore forming agent from the sheet obtained in step (iii) and then stretching the sheet, or by stretching the sheet obtained in step (iii) and then removing the pore forming agent from the sheet; and
(v) annealing the porous film at a temperature of less than Tm but not less than (Tm−30° C.), wherein Tm is a melting point of the polyolefin contained in the porous film.

15. The method as set forth in claim 14, wherein the polyolefin is polyethylene.

16. The method as set forth in claim 14, wherein the second mixture has an untamped density of not less than 500 g/L.

17. The method as set forth in claim 14, wherein the nonaqueous electrolyte secondary battery separator has a parameter X of not more than 20, wherein the parameter X is calculated based on the following equation:
X100×|MD tan δ−TD tan δ|/{(MD tan δ+TD tan δ)/2},
where MD tan δ is tan δ in a machine direction of the porous film and TD tan δ is tan δ in a transverse direction of the porous film,
MD tan δ and TD tan δ each being obtained by viscoelasticity measurement carried out with respect to the porous film at a frequency of 10 Hz and a temperature of 90° C.

18. The method as set forth in claim 14, wherein the nonaqueous electrolyte secondary battery separator has a puncture strength of not less than 3 N.

19. The method as set forth in claim 14, wherein the porous film has a thickness of 4 μm to 40 μm.

20. The method as set forth in claim 14, wherein the porous film has a volume-based porosity of 20% to 80%.

21. The method as set forth in claim 14, wherein the porous film contains pores having an average pore diameter of 0.3 μm or less.

22. The method as set forth in claim 14, wherein the ultra-high molecular weight polyethylene has a weight-average molecular weight of 1,000,000 or more.

23. The method as set forth in claim 14, wherein the low molecular weight hydrocarbon has a weight-average molecular weight of not more than 10,000.

24. The method as set forth in claim 14, wherein the first mixture further comprises an antioxidant.

25. The method as set forth in claim 14, wherein the porous film has no micro regions of mechanical nonuniformity.

26. The method as set forth in claim 14, wherein the pore forming agent is an inorganic filler or a plasticizer.
